(19) United States
(12) Patent Application Publication
(10) Pub. No.: US 2009/0102733 A1
(43) Pub. Date: Apr. 23, 2009

(54) ANTENNA SYSTEM AND METHOD FOR CONTROLLING AN ANTENNA PATTERN OF A COMMUNICATION DEVICE

(75) Inventors: Mark M. Kanne, Chandler, AZ (US); Kenneth B. Riordan, Spring Grove, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/873,492

(22) Filed: Oct. 17, 2007

(51) Int. Cl. H01Q 3/02

(52) U.S. Cl. 343/757

(57) ABSTRACT

The present invention provides an antenna system and method for controlling an antenna pattern in a communication device. The antenna system comprises one or more rotatable antennas and one or more antenna reflectors. The one or more antenna reflectors are electrically isolated reflecting surfaces that are operationally coupled to the one or more rotatable antennas. The method comprises aligning the one or more rotatable antennas in one or more positions with respect to the one or more antenna reflectors so as to provide a repeatable antenna pattern.

### FIELD OF THE INVENTION

The present invention generally relates to wireless communication devices, and more specifically, to an antenna system within a wireless communication device.

### BACKGROUND OF THE INVENTION

Wireless communication systems that utilize radio frequency (RF) signals to transmit and receive data are well known. Wireless data communication can be applied to short distance local area network (LAN) communication systems, such as wireless LAN within a home or office environment. In the case of short distance wireless LAN communication, a wireless access system may include a customer premises equipment (CPE) that is connected to an office or home computer, via an Ethernet interface, for example. Customer-premises equipment or customer-provided equipment (CPE) is any terminal and associated equipment and inside wiring located at a subscriber's premises and connected with a carrier's telecommunication channel(s). CPEs that enable a consumer to connect to the wireless data communication network may include, for example, telephones, digital subscriber line (DSL) modems, cable modems or set top boxes located at customer's premises for use with communication service providers' services.

Today's CPEs generally operate using an internal omni-directional antenna system which transmits and receives power uniformly in one plane with a directive pattern shape in a perpendicular plane. It is well known in the art that antennas are characterized by directivity and gain. The directivity of an antenna is the ability of the antenna to focus RF energy in a particular direction. The gain of an antenna is the attained increase in signal strength.

Typically, CPEs include one or more antennas for RF communication. However, the radiation from the RF signal from the one or more antennas may be absorbed by ground planes of electronic circuit boards of the CPEs. This may result in a non-uniform antenna pattern, consequently, reducing the performance of the CPE.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view of an antenna system of a communication device in accordance with an embodiment of the present invention.

FIG. 2 illustrates a front view of the communication device of the FIG. 1 in accordance with an embodiment of the present invention.

FIG. 3 illustrates a side view of the communication device of the FIG. 1 in accordance with an embodiment of the present invention.

FIG. 4 is a flow diagram of a method for controlling antenna pattern of a communication device in accordance with an embodiment of the present invention.

FIG. 5 illustrates a simplified schematic view of the antenna pattern of an antenna system of the communication device of FIG. 1 in accordance with an embodiment of the present invention.

FIG. 6 illustrates a simplified schematic view of the antenna pattern of an antenna system of the communication device of FIG. 1 in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to an antenna system and method for use within a wireless communication device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the present invention described herein may be comprised of one or more conventional transaction-clients and unique stored program instructions that control the one or more transaction-clients to implement, in conjunction with certain non-transaction-client circuits, some, most, or all of the functions of a method for operation of an antenna system of a wireless communication device. The non-transaction-client circuits may include, but are not limited to, a radio receiver, a radio transmitter, signal drivers, clock circuits, power source circuits, and user input devices. As such, these functions may be interpreted as steps of a method for operation of an antenna system of a wireless communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the description herein, numerous specific examples are given to provide a thorough understanding of various embodiments of the invention. The examples are included for illustrative purpose only and are not intended to be exhaustive or to limit the invention in any way. It should be noted that various equivalent modifications are possible within the spirit and scope of the present invention. One skilled in the relevant art will recognize, however, that an embodiment of the invention can be practiced with or without the apparatuses, systems, assemblies, methods, components mentioned in the description.

Pursuant to various embodiments, the present invention provides an antenna system and method of operation within a wireless communication device. The communication device, for example, may receive and transmit signals in a short distance wireless local area network (WLAN) within a home or office network using the antenna system. The present invention provides an antenna system and method for controlling an antenna pattern of the antenna system, such that performance of the antenna system is enhanced and a repeatable antenna pattern is obtained. Those skilled in the art will appreciate that the present invention may be applied to various types of communication devices, irrespective of the structure of the communication devices, with little or no modifications to the disclosed antenna system and method.

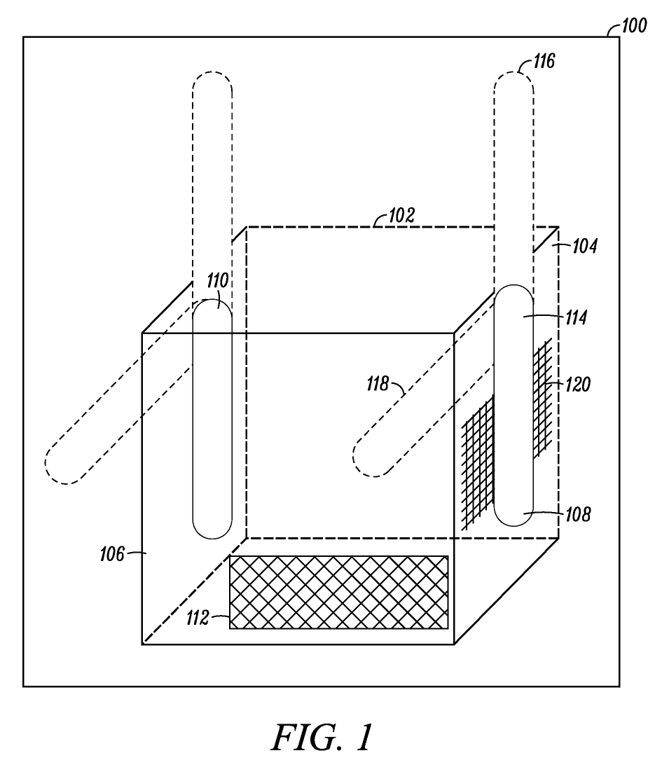

Referring to the drawings and in particular to FIG. 1, a perspective view of an antenna system of a communication device is shown in accordance with an embodiment of the present invention. A communication device 100 as shown in FIG. 1 may be a Customer Premises Equipment (CPE). The CPE may be, but is not limited to, a Digital subscriber line (DSL) modem, a Local area network (LAN) access modem, a wireless area network (WAN) access modem, and a Worldwide Interoperability for Microwave Access (Wimax) modem. Although not illustrated, it will be appreciated by those of ordinary skill in the art that the communication device, in accordance with some embodiments of the present invention, can alternatively be a two-way radio, a Personal Digital Assistant (PDA) with communication capabilities, a laptop computer with communication capabilities, a messaging device, a mobile telephone, and the like.

The communication device 100 includes a housing 102. The housing 102 provides a protective covering for the electronic components such as printed circuit boards and a microprocessor of the communication device 100. The housing 102 can be made of a hard plastic molded in the required shape. The housing 102 can also be made of metal or any other equivalent material. The housing 102 also aids in keeping components such as a keypad intact.

The housing 102 includes a plurality of housing sides. One of the housing sides is depicted as a housing side 104, and a second housing side opposite to the housing side 104 is depicted as a housing side 106. Those skilled in the art will appreciate that even though the communication device 100 is depicted to have a cubic structure in FIG. 1, the present invention may be applicable to a variety of shapes and structures.

The communication device 100 has a rotatable antenna 108 and a rotatable antenna 110 attached to the housing 102 to receive and transmit communication signals. The rotatable antenna 108 is mounted on the housing side 104 of the communication device 100 and the rotatable antenna 110 is mounted on the housing side 106 of the communication device 100. The rotatable antenna 108 and the rotatable antenna 110 may be mounted such that they are rotatable around a joint on the housing side 104 and on the housing side 106 respectively. Further, the communication device 100 may include an electronic circuit board 112 used for affixing the various electronics utilized in the operation of the communication device. The electronic circuit board 112 may include one or more ground planes.

In an embodiment of the present invention, the rotatable antenna 108 and the rotatable antenna 110 may be one or more omni-directional array antennas, which produce an omni-directional antenna pattern. The rotatable antenna 108 and the rotatable antenna 110 receive and radiate in all directions in a plane and exhibit uniform antenna pattern. For instance, the rotatable antenna 108 and the rotatable antenna 110 may include a four dipole co-linear omni-directional array. It would be apparent to a person skilled in the art that, in accordance with the various embodiments of the present invention, any number and/or type of rotatable antennas may be attached to the housing 102 of the communication device 100. For instance, in one embodiment, the communication device 100 may include a rotatable antenna attached to each of the plurality of housing sides of the housing 102. Similarly, in another embodiment of the present embodiment, only one antenna may be attached to the housing 102 of the communication device 100.

In an embodiment of the present invention, the rotatable antenna 108 and the rotatable antenna 110 are attached to opposite housing sides of the housing 102. For instance, the rotatable antenna 108 is attached to the housing side 104 and the rotatable antenna 110 is attached to the housing side 106. Consequently, the rotatable antenna 108 and the rotatable antenna 110 may form a dipole of omni-directional antennas.

Those skilled in the art will appreciate that the rotatable antenna 108 and the rotatable antenna 110 may be attached to any of the plurality of housing sides of the housing 102, based on a desired performance of the communication device 100.

In accordance with an embodiment of the present invention, the rotatable antenna 108 may be rotated in order to position the rotatable antenna 108 in a plurality of positions with respect to the housing side 104. Some of the positions of the plurality of positions may be for instance, a retracted position 114, an extended position 116 and an intermediate position 118 which is a rotated position with respect to the retracted position 114 and the extended position 116. A position 114 of the rotatable antenna 108, as depicted in FIG. 1, is the retracted position. In the retracted position 114, the rotatable antenna 108 is positioned in a downward direction with respect to the housing 102. Typically, in indoor environment or space-constrained locations, the rotatable antenna 108 may be positioned in the position 114 in order to save space required for installation and deployment of the communication device 100. The rotatable antenna 108 may further be rotated to the extended position 116, and the intermediate position 118. In the extended position 116, the rotatable antenna 108 is positioned in an upward direction with respect to the housing 102. Similarly, in the intermediate position 118, the rotatable antenna 108 is positioned in a position between the extended position 116 and the retracted position 114 or in a plane approximately parallel to the ground. Those skilled in the art will appreciate that, in accordance with the various embodiments of the present invention, the rotatable antenna 108 and the rotatable antenna 110 may be positioned in positions other that the extended position 116, the retracted position 114 and the intermediate position 118.

In accordance with various embodiments of the present invention, the housing 102 further includes one or more antenna reflectors, which may be attached to one or more housing sides of the housing 102. For instance, an antenna reflector 120 is attached to the housing side 104 of the housing 102. The one or more antenna reflectors function as electrically isolating reflecting surfaces. An antenna reflector may also be attached to other housing sides of the housing 102. For instance, an antenna reflector may be attached to the housing side 106 (not shown in FIG. 1).

Further, in an embodiment of the present invention, the antenna reflector 120 may be attached to an outside surface of the housing side 104. In this embodiment, the antenna reflector 120 is located between the rotatable antenna 108 and the housing side 104. Alternatively, in another embodiment of the present invention, the antenna reflector 120 may be attached to an inside surface of the housing side 104. In this embodiment, the housing side 104 is located between the antenna reflector 120 and the rotatable antenna 108. Similarly, the antenna reflector attached to the housing side 106 may be attached to either an inside surface or an outside surface of the housing side 106.

The one or more antenna reflectors may have a characteristic shape based on, for example, the frequency of operation of the rotatable antennas or the desired antenna pattern. The characteristic shape may be, for example, an elliptical contour, a hyperbolic contour, or a parabolic contour.

Further, the antenna reflectors may include, for example, a metal coating or ceramic fibers. The metal coating may be selected from such materials as gold, copper, tungsten or their alloys thereof. The ceramic fibers may be comprised of such materials as silicon di-oxide, aluminum oxide, and the like.

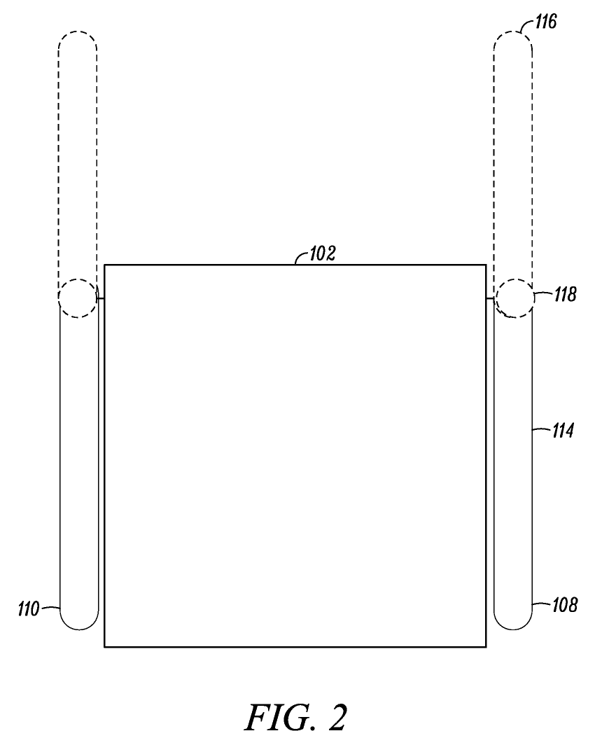

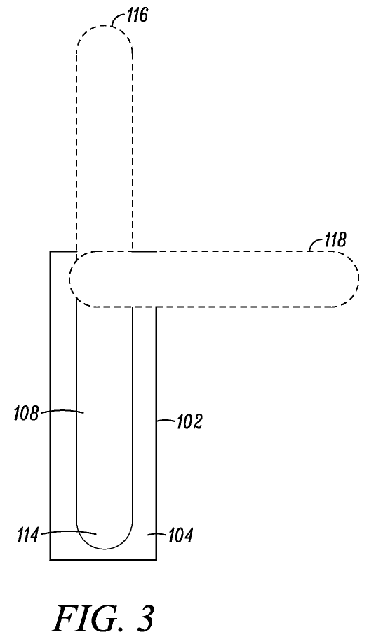

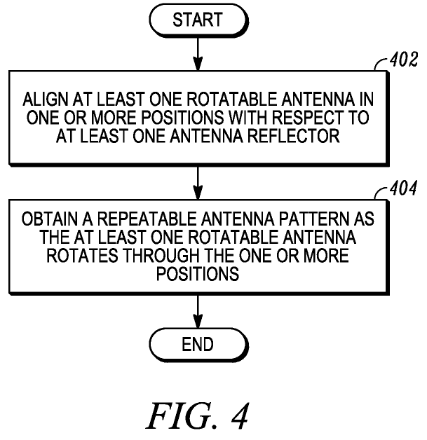

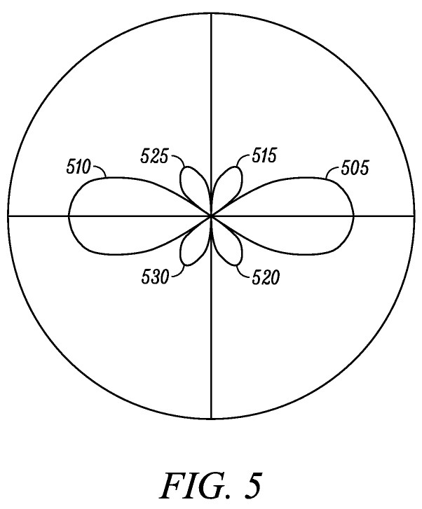

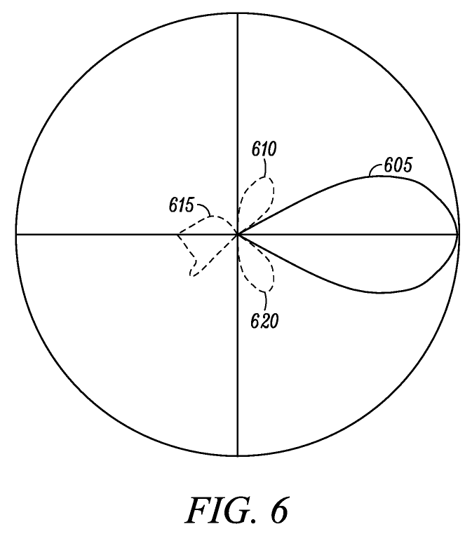

As described previously herein, the one or more antenna reflectors function as electrically isolating reflecting surfaces, which diminish the effect of the one or more ground planes of the electronic circuit board 112 on the antenna pattern of the antenna system. Consequently, using the antenna reflectors, the antenna pattern produced when the rotatable antenna 108 and the rotatable antenna 110 are in the retracted position 114 is controlled and a desired antenna pattern obtained. The method for controlling the antenna pattern is explained in conjunction with FIG. 2, FIG. 3, FIG. 4, FIG. 5 and FIG. 6.

Turning now to FIG. 2, a front view of the communication device 100 of FIG. 1 is shown in accordance with an embodiment of the present invention. FIG. 2 illustrates the front view of the communication device 100 in an embodiment, wherein the rotatable antenna 108 and the rotatable antenna 110 are in the retracted position 114 with respect to the housing 102. The rotatable antenna 108 can be rotated to the extended position 116, or the intermediate position 118, which is perpendicular to the plane of the page. Similarly, the rotatable antenna 110 can be rotated to an extended position or to an intermediate position.

FIG. 3 illustrates a side view of the communication device 100, wherein the rotatable antenna 108 is in the retracted position 114 with respect to the housing 102. The rotatable antenna 108 can be rotated to the extended position 116, or the intermediate position 118. Although, the intermediate position 118 is shown to be perpendicular to the extended position 116, the intermediate position 118 may be any other position between the retracted position 114 and the extended position 116 in other embodiments. The rotatable antenna 110 can also be rotated to an extended position or to an intermediate position in a similar manner.

Those skilled in the art will appreciate that elements in the FIG. 1, FIG. 2 and FIG. 3 are illustrated for simplicity and clarity and have not necessarily been drawn to scale. The shapes and the sizes of the elements of the communication device 100 described in FIG. 1, FIG. 2 and FIG. 3 is only illustrative and is not conclusive.

FIG. 4 is a flow diagram of a method for controlling an antenna pattern of the communication device 100. It will be appreciated by those of ordinary skill in the art that the method of FIG. 4 may be used for controlling the antenna pattern of a communication device irrespective of the shape or size of the communication device.

As described previously, the communication device 100 uses the rotatable antenna 108 and the rotatable antenna 110 to receive and transmit signals. Further, the rotatable antenna 108 and the rotatable antenna 110 may be mounted to opposite housing sides of the housing 102. For instance, the rotatable antenna 108 is attached to the housing side 104, while the rotatable antenna 110 is attached to the housing side 106.

Further, as described in FIG. 1, the antenna reflector 120 is attached to either the inside surface or the outside surface of the housing side 104. Similarly, an antenna reflector may be attached to either the inside surface or the outside surface of the housing side 106. In an embodiment, the antenna reflectors may be attached to housing sides other than the housing side 104 and the housing side 106. As described previously, the antenna reflectors function as electrically isolating surfaces and reflect back the radiated power from the communication device 100, thus mitigating the effect of the one or more ground planes of the electrical circuit board 112 on the antenna pattern.

At step 402, one or more rotatable antennas of the communication device 100 are aligned in one or more positions with respect to the antenna reflectors. For instance, the rotatable antenna 108 may be rotated and aligned in the one or more positions with respect to the antenna reflector 120. The rotatable antenna 108 may be positioned in, for instance, the extended position 116, the intermediate position 118, or the retracted position 114.

In accordance with the present invention, when the rotatable antenna 108 is aligned in the retracted position 114, some of the RF radiation from the rotatable antenna 108 is directed towards the interior region of the housing 102. However, the antenna reflector 120 reflects the RF radiation, which is directed towards the interior region of the housing 102, and reflects it back to the rotatable antenna 108. Similarly, an antenna reflector on the housing side 106 reflects RF radiation from the rotatable antenna 110 away from the interior of the housing 102 and back to the rotatable antenna 110. Consequently, even when the rotatable antennas are in the retracted position 114, the antenna pattern results in strong signal conditions. If stronger signal conditions are desired, the rotatable antennas may be aligned in the extended position 116. In some embodiments of the present invention, aligning the rotatable antennas in the retracted position 114 may result in stronger signal conditions than aligning the rotatable antennas in the extended position 116.

The rotatable antenna 108 may also be moved to the intermediate position 118 depending upon the location constraints and signal conditions. In the intermediate position 118, some of the RF radiation from the rotatable antenna 108 may be directed towards the interior region of the housing 102 through housing sides other than the housing side 104 and the housing side 106. Consequently, antenna reflectors may be attached to housing sides other than the housing side 104 and the housing side 106 in order to reflect back the RF radiation to the rotatable antennas. The rotatable antenna 110 can also be rotated with respect to the housing side 106 in order to be aligned in the one or more positions similar to those of the rotatable antenna 108.

Consequent to aligning the rotatable antenna 108 to the one or more positions, a desired repeatable antenna pattern is obtained at step 404.

For instance, the rotatable antenna 108, when aligned in the extended position 116 may receive and transmit signals uniformly in all directions in a plane. Particularly, the rotatable antenna 108 may be aligned in the extended position 116 when the signal conditions are weak.

In another instance, when the rotatable antenna 108 is aligned in the retracted position 114, the antenna reflector 120 directs the RF radiation in an outward direction and away from the interior of the housing 102. This improves the performance of the rotatable antenna 108. Specifically, the antenna reflector 120 directs the RF radiation in a direction away from the interior of the housing and, in turn, increases the gain and modulates the directivity of the RF radiation. Hence, the rotatable antenna 108 may be aligned in the retracted position 114 to obtain a controlled directed antenna pattern. The controlled directed antenna pattern of the rotatable antenna 108 is further explained in FIG. 5 and FIG. 6.

FIG. 5 illustrates a simplified schematic view of the antenna pattern for an antenna system of the communication device 100 of FIG. 1 in accordance with an embodiment of the present invention. In particular, FIG. 5 shows the antenna pattern of the rotatable antenna 108 in the extended position 116, assuming that the rotatable antenna 108 is in the plane of the page. If the rotatable antenna 108 is an omni-directional antenna, the antenna pattern of FIG. 5 is a doughnut shaped antenna pattern perpendicular to the plane of the page. A lobe 505 and a lobe 510 correspond to the antenna pattern. A side-lobe 515, a side-lobe 520, a side-lobe 525 and a side-lobe 530 are the side-lobes of the antenna pattern. The antenna pattern is characterized by the gain of the antenna pattern. The gain generally depends on the frequency of operation of the rotatable antenna 108. For instance, the gain may be 6 decibel isotropic (dBi) when the frequency of operation of the rotatable antenna is 3500 Mega hertz (MHz).

FIG. 6 illustrates a simplified schematic view of the antenna pattern for an antenna system of the communication device 100 of FIG. 1 in accordance with an embodiment of the present invention. In particular, FIG. 6 shows the antenna pattern of the rotatable antenna 108 in the retracted position 114, assuming that the rotatable antenna 108 is in the plane of the page. In the retracted position 114, the antenna reflector 120 receives some of the RF radiation from the rotatable antenna 108 and reflects the RF radiation in the direction opposite to the interior region. Consequently, the antenna pattern produced by the rotatable antenna 108 in the retracted position 114 has only on major lobe, such as a lobe 605, and may have one or more side-lobes, such as a side lobe 610, a side-lobe 615 and a side-lobe 620. Further, the directivity and gain of the lobe 605 is higher as compared to the lobe 505 and the lobe 510 of FIG. 5. For instance, the gain may be 8 dBi when the frequency of operation of the rotatable antenna is 3500 MHz, instead of the 6 dBi gain obtained in FIG. 5. This is because the antenna reflector 120 concentrates the RF radiation in a direction away from the interior region and towards the rotatable antenna 108.

Those skilled in the art will realize that the antenna patterns depicted in FIG. 5 and FIG. 6 are illustrated for simplicity and clarity and have not necessarily been drawn to scale. The shapes of the antenna patterns described in FIG. 5 and FIG. 6 are only illustrative and are not conclusive.

Various embodiments of the present invention provide an antenna system and method for controlling antenna pattern of a communication device. Further, various embodiments of the present invention enable effective usage of a communication device in its compact and aesthetic form. In addition, various embodiments of the present invention provide a method and antenna system for forming selective beam patterns with high directivity and gain using one or more antenna reflectors.

Those skilled in the art will appreciate that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. An antenna system within a communication device, the antenna system comprising:
at least one rotatable antenna; and
at least one antenna reflector, wherein the at least one antenna reflector is an electrically isolated reflecting surface, wherein the at least one antenna reflector is operationally coupled to the at least one rotatable antenna to provide a repeatable antenna pattern for the at least one rotatable antenna as the at least one rotatable antenna rotates through one or more positions.

2. The antenna system of claim 1, wherein the communication device includes a housing comprising a plurality of housing sides, wherein the at least one antenna reflector is attached to at least one housing side of the plurality of housing sides.

3. The antenna system of claim 2, wherein the at least one antenna reflector is attached to an inside surface of a housing side of the communication device.

4. The antenna system of claim 2, wherein the at least one antenna reflector is attached to an outside surface of a housing side of the communication device.

5. The antenna system of claim 2, wherein a first antenna reflector is attached to a first housing side and a second antenna reflector is attached to a second housing side, wherein the first housing side is opposite to the second housing side, the first housing side and the second housing side belonging to the plurality of housing sides.

6. The antenna system of claim 2, wherein the communication device further comprises at least one electronic circuit board, and further wherein the at least one antenna reflector reflects one or more communication signals back to the at least one antenna and away from at least one electronic circuit board.

7. The antenna system of claim 6, wherein the at least one electronic circuit board includes a ground plane, and further wherein the at least one antenna reflector further provides isolation from an interference of the ground plane.

8. The antenna system of claim 1, wherein the one or more positions include at least one of an extended position, a retracted position and an intermediate position.

9. The antenna system of claim 1, wherein the one or more positions include an upward and a downward position, wherein the at least one rotatable antenna operates in the downward position in response to a strong signal condition, and further wherein the at least one rotatable antenna operates in an upward position in response to a weak signal condition.

10. The antenna system of claim 1, wherein the at least one rotatable antenna comprises an omni-directional array antenna, the at least one rotatable antenna producing an omni-directional antenna pattern.

11. The antenna system of claim 1, wherein the at least one antenna reflector has at least one of an elliptical contour, a hyperbolic contour and a parabolic contour, based on at least one of a frequency of operation of the at least one rotatable antenna and a desired antenna pattern.

12. The antenna system of claim 1, wherein the at least one antenna reflector comprises at least one of a metal coating and one or more ceramic fibers.

13. A method of controlling an antenna pattern of a communication device, the communication device comprising a housing, the housing comprising a plurality of housing sides, the method comprising:
aligning at least one rotatable antenna in one or more positions with respect to at least one antenna reflector, the at least one antenna reflector being an electrically isolated reflecting surface, wherein the at least one antenna reflector is operationally coupled to the at least one rotatable antenna to provide a repeatable antenna pattern for the at least one rotatable antenna as the at least one rotatable antenna rotates through the one or more positions.

14. The method of claim 13, wherein the at least one antenna reflector is attached to an inside surface of a housing side of the communication device.

15. The method of claim 13, wherein the at least one antenna reflector is attached to an outside surface of a housing side of the communication device.

16. The method of claim 13, wherein the one or more positions is at least one of an extended position, a retracted position and an intermediate position.

17. The method of claim 13, wherein the one or more positions include an upward and a downward position, wherein the at least one rotatable antenna operates in the download position in response to a strong signal condition, and further wherein the at least one rotatable antenna operates in an upward position in response to a weak signal condition.
